(19) United States
(12) Patent Application Publication
(10) Pub. No.: US 2005/0226469 A1
(43) Pub. Date: Oct. 13, 2005

(54) Method for displaying finger images in wireless telecommunication terminal

(76) Inventor: Jong-Hwan Ho, Incheon (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/076,581

(22) Filed: Mar. 8, 2005

(30) Foreign Application Priority Data
Apr. 7, 2004 (KR) 10-2004-0023751

(51) Int. Cl. G06K 9/00

(52) U.S. Cl. 382/115; 340/5.83; 455/411

(57) ABSTRACT

A finger image displaying method provides a user with a visual characteristic, identification and convenience by outputting a finger image on which a state of each fingerprint is displayed, then, if a certain finger is selected by the user, establishing fingerprint registration, a fingerprint identification function and a detailed fingerprint identification function for the selected finger, and expressing a finger image corresponding to the selected finger. The, the method includes the step of registering a fingerprint by using a finger image as a fingerprint registration request signal is inputted and then displaying a finger image representing a fingerprint registration state corresponding to the fingerprint, and the step of setting up a fingerprint identification function corresponding to the selection of each fingerprint in response to a fingerprint identification function set-up signal and then displaying a finger image representing a set-up state of the fingerprint identification function.

### FIELD OF THE INVENTION

The present invention relates to a method for displaying finger images in a wireless telecommunication terminal; and, in particular, to a finger image displaying method for providing a user with a visual characteristic, identification and convenience by outputting a finger image on which there is displayed a state of each fingerprint, then, if a certain finger is selected by the user, setting up fingerprint registration, a fingerprint identification function and a detailed fingerprint identification function for the selected finger, and expressing a finger image corresponding to the selected finger.

### BACKGROUND OF THE INVENTION

In this present invention, the wireless telecommunication terminal means a terminal, which an individual carries and through which wireless telecommunication can be performed, such as a mobile communication terminal, a personal communication service (PCS) terminal, a personal digital assistant (PDA), a smart-phone, a international mobile telecommunication (IMT-2000) terminal, a wireless LAN device and so on.

In general, a fingerprint is formed by a constant flow of swelled sweat glands and its scientific research is started in the middle 1800's. From the research, it is noticed that there are two important characteristics of a fingerprint accepted as facts so far. Firstly, fingerprints of two different fingers do not have the same ridge form and, secondly, the ridge form of a fingerprint does not change for a whole life.

Because of the above characteristics, fingerprint identification technology has excellent characteristics in accuracy, a processing speed and so on as well as being known the most effective in the side of performance, cost, user convenience, market construction, etc, compared to other biometric identification technology such as retina, iris, blood vessel, facial recognition, etc.

Meanwhile, a fingerprint input scheme can be classified to an optical type and a non-optical type. The optical type uses the reflection of light while the non-optical type uses pressure and heat of fingers or supersonic waves.

Since the optical type requires a radiation part, a lens and a camera necessarily, its volume and manufacturing cost are high while it is strong against external impact and scratch of an input part and has high stability since its place is fixed.

On the other hand, since the non-optical type is formed with one semiconductor device, its volume is small and its mass production is possible. As a result, its manufacturing cost is low while it is weak to scratch of contact surface and external impact and sensitive to external environment variation such as static electricity, temperature, humidity and so on.

In the meantime, in 1901, Edward Henry started to use the fingerprint for identification to conveniently manage the payroll of railroad workers. In the late 1960's, there was developed a live-scan system capable of electrically recording human fingerprints and, thus, this field marked a notable epoch-making transitional period. Then, there has been developed a technology of making a database of many fingerprints and automatically distinguishing and detecting the fingerprints. From the early 1990's, the interest in an application field for fingerprint identification technology become higher with the development of computer communication and its development fields were diversified.

The fingerprint identification has been used to perform the identification of an individual for a long time. Specially, as the interest in the privacy protection and security becomes higher with the development of a network,

An automated fingerprint identification technology as personal authentication is being developed as a field of technology in the limelight among image identification technology. Furthermore, as the research for the fingerprint identification technology is enhanced, an input sensor becomes integrated in a further smaller size and the technology is expanded to application fields like electric commercial transaction through a network.

Referring to FIG. 2, there is provided a view of explaining a method for displaying a fingerprint registration state and authentication process in a wireless telecommunication terminal.

According to the method, a fingerprint is scanned by using a fingerprint scan sensor and then registered. At this time, registered fingerprint data is constructed in a list form 21 to be displayed to users. At a time of fingerprint identification and authentication, the fingerprint scan sensor is actuated and a standby screen 22 is only displayed.

The fingerprint identification method used in the small devices such as notebook, wireless telecommunication terminal, PDA, etc. is also utilized in various applications for the security like access control, data security and authentication of the electric commercial transaction. However, since the fingerprint registration state is displayed in a list form at those cases, there is a problem of identification and a visual characteristic deteriorated.

Moreover, since it is impossible to distinguish which fingerprint is a fingerprint relating to the fingerprint identification and authentication, there is a problem of inducing inconvenience of scanning the selected fingerprint again after other fingerprints are scanned.

### SUMMARY OF THE INVENTION

One aspect of the invention is a method of utilizing a fingerprint in a wireless telecommunication terminal. The method may comprise: displaying an image indicative of a hand, the hand image comprising a plurality of fingers; and displaying information indicative of a fingerprint of a first one of the fingers being registered. In this method, the fingerprint registration information may be displayed along with the hand image. The method may further comprise displaying information indicative of which finger is associated with a terminal operating function. The plurality of fingers may comprise a second finger, and the method may further comprise displaying information which indicates that a terminal operating function is assigned to the second finger. A fingerprint may be registered for the second finger, and the method may further comprise inputting to the terminal fingerprint information of the second finger. If the input fingerprint information matches the registered fingerprint, the terminal may initiate or continue the terminal operating function. The terminal operating function may comprise authenticating a user of the terminal when the user attempts to access information stored in the terminal or in a remote electronic device that can be accessed by the terminal. The terminal operating function may comprise speed dialing which initiates or prepares for connection of the terminal to a remote electronic device without inputting a full number or address of the remote electronic device.

In the above-described method, the plurality of fingers may further comprise a third finger, and the method may further comprise registering a fingerprint for the third finger. Registering a fingerprint may comprise inputting a fingerprint image to the terminal; and selecting the third finger from the hand image. Inputting a fingerprint image may comprise obtaining a fingerprint image directly from a finger of a user or receiving fingerprint image data from an electronic device connected to the terminal. Registering a fingerprint may comprise storing a fingerprint image for the third finger or replacing a preexisting fingerprint image with a new fingerprint image for the third finger. Registering a fingerprint may further comprise inputting a predetermined user password to the terminal.

Another aspect of the invention provides a method of utilizing a fingerprint in a handheld electronic device. The method comprises: displaying information indicative of which finger is associated with a function of the handheld electronic device; inputting to the device fingerprint information; and proceeding with operation of the function if the input fingerprint information matches a stored fingerprint information of the finger that is associated with the function. The information may be displayed along with an image representing a hand. The function may comprise authenticating a user of the device, and the information may be displayed when the user attempts to use the device. The function may comprise authenticating a user of the device, and the information may be displayed when the user attempts to access information stored in the device or in a remote electronic device that can be accessed by the device. The information may be displayed upon user request or when the function is needed. The information may be displayed when input fingerprint information fails to match the stored fingerprint of the finger.

Still another aspect of the invention provides a method of utilizing a fingerprint in a handheld electronic device. The method comprises: displaying an image representing a hand, the image comprising a plurality of fingers; and displaying information indicative of a function of the device being assigned to one of the fingers. The may further comprise inputting to the device fingerprint information of the finger, and if the input fingerprint information matches a stored fingerprint of the finger to which the function is assigned, the device initiates or continues the device operating function. The device operating function may comprise authenticating a user of the device, and the information may be displayed when the user attempts to access information stored in the device or in a remote electronic device that can be accessed by the device. The device operating function may comprise speed dialing which initiates or prepares for connection of the device to a remote electronic device without inputting a full number or address of the remote electronic device.

It is, therefore, an object of the present invention to provide a finger image displaying method for providing a user with a visual characteristic, identification and convenience by outputting a finger image on which there is indicated a state of each fingerprint, then, if a certain finger is selected by the user, setting up fingerprint registration, a fingerprint identification function and a detailed fingerprint identification function for the selected finger, and expressing a finger image corresponding to the selected finger.

In accordance with one scope of the present invention, there is provided a method for displaying finger images in a wireless telecommunication terminal, which includes a fingerprint registration displaying step of registering a fingerprint by using a finger image as a fingerprint registration request signal is inputted and then displaying a finger image representing a fingerprint registration state corresponding to said fingerprint, and a first fingerprint identification application displaying step of setting up a fingerprint identification function corresponding to the selection of each fingerprint in response to a fingerprint identification function set-up signal and then displaying a finger image representing a set-up state of the fingerprint identification function.

The method in accordance with one scope of the present invention further includes a second fingerprint identification application displaying step of setting up a detailed fingerprint identification function corresponding to the selection of each fingerprint as a detailed fingerprint identification function set-up signal is inputted and then displaying a finger image on which the detailed fingerprint identification function is set up.

The method in accordance with one scope of the present invention still further includes an authenticated fingerprint report displaying step of displaying a finger image representing a finger registered as fingerprint data for authentication when fingerprint authentication is required.

In accordance with another scope of the present invention, there is provided a method for displaying finger images in a wireless telecommunication terminal, which includes a fingerprint registration displaying step of registering a fingerprint by using a finger image as a fingerprint registration request signal is inputted and then displaying a finger image representing a fingerprint registration state corresponding to said fingerprint, and an authenticated fingerprint report displaying step of displaying a finger image representing a finger registered as fingerprint data for authentication when fingerprint authentication is required.

### BRIEF DESCRIPTION OF THE DRAWINGS

The above and other objects and features of the present invention will become apparent from the following description of preferred embodiments given in conjunction with the accompanying drawings, in which:

FIG. 1 shows a block diagram of a wireless telecommunication terminal in accordance with the present invention;

FIG. 2 provides a view of explaining a method for displaying a fingerprint registration state and authentication process in a wireless telecommunication terminal;

FIGS. 3A to 3F represent views of explaining a method for displaying fingerprint registration in the wireless telecommunication terminal in accordance with the present invention;

FIGS. 4A to 4C describe views of explaining a method for displaying the establishment of a fingerprint identification function in the wireless telecommunication terminal in accordance with the present invention;

FIGS. 5A to 5E present views of explaining a method for displaying the establishment of a detailed fingerprint identification function in the wireless telecommunication terminal in accordance with the present invention;

FIG. 6 depicts a view of explaining a method for displaying fingerprint authentication in the wireless telecommunication terminal in accordance with the present invention; and

FIG. 7 illustrates a flowchart of showing a method for displaying finger images in the wireless telecommunication terminal in accordance with the present invention.

### DETAILED DESCRIPTION OF THE PREFERRED EMBODIMENTS

Hereinafter, with reference to the drawings, the preferred embodiment of the present invention will be explained in detail.

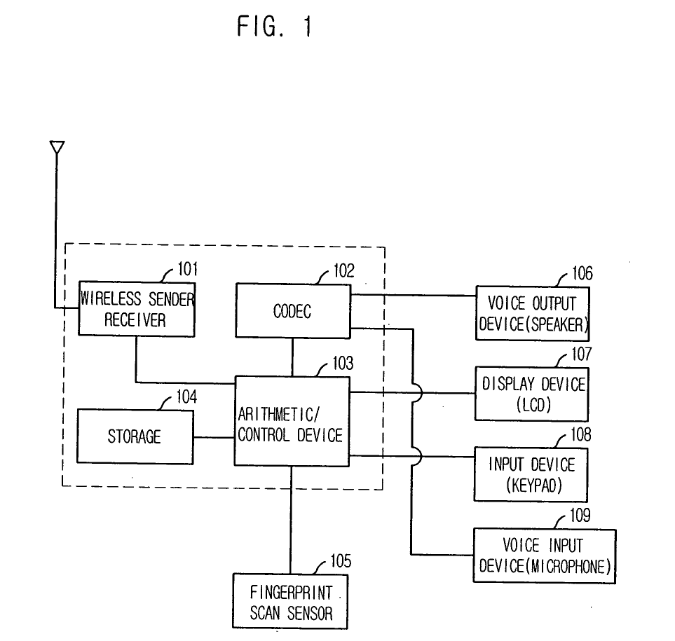

FIG. 1 shows a block diagram of a wireless telecommunication terminal in accordance with the preferred embodiment of the present invention.

In FIG. 1, the inventive wireless telecommunication terminal includes a wireless sender/receiver 101, a CODEC 102, an arithmetic/control device 103, a storage 104, a fingerprint scan sensor 105, a voice output device 106, a display device 107, an input device 108 and a voice input device 109.

The wireless sender/receiver 101 wirelessly sends and receives signals through an antenna.

Under the control of the arithmetic/control device 103, the CODEC 102 converts signals provided from the wireless sender/receiver 101 to voices to thereby transmit the voices to the voice output device 106, and converts voices transmitted from the voice input device 109 to signals to thereby deliver the signals to the arithmetic/control device 103 and make the signals being outputted through the wireless sender/receiver 101.

The storage 104 stores a program for driving the wireless telecommunication terminal, fingerprint data, a program for finger image display, a file system (image, character, icon, etc.) for the finger image display and so on.

The fingerprint scan sensor 105 scans fingerprints by being actuated under the control of the arithmetic/control device 103 and transmits scanned fingerprint data to the arithmetic/control device 103.

The voice output device 106 outputs the voices coupled from the CODEC 102.

The display device 107 outputs a screen, e.g., finger image, under the control of the arithmetic/control device 103.

The input device 108 receives a telephone number, menu selection information, a fingerprint registration request signal, a fingerprint identification function set-up signal, a detailed fingerprint identification function set-up signal, etc. through buttons.

The voice input device 109 receives voices and transmits them to the CODEC 102.

The arithmetic/control device 103 drives and controls the wireless telecommunication terminal. For that, the arithmetic/control device 103 controls components of the wireless telecommunication terminal so as to execute, in response to the fingerprint registration request signal, functions of displaying a finger image whereon a fingerprint state is indicated on the display device 107 to get a certain finger that is selected, storing fingerprint data transmitted from the fingerprint scan sensor 105 corresponding to the selected finger in the storage 104, registering the fingerprint data, and then displaying a finger image representing a registration state on the display device 107; in response to the fingerprint identification function set-up signal, functions of setting up a fingerprint function according to the fingerprint selection and displaying a finger image representing a set-up state on the display device 107; in response to the detailed fingerprint identification function set-up signal, functions of establishing a detailed function according to the fingerprint selection among detailed functions included the fingerprint identification function and displaying a finger image in which the established detailed function is indicated on the display device 107; and, since the fingerprint authentication is required, a function of displaying a finger image representing a finger registered as the fingerprint data for the authentication on the display device 107.

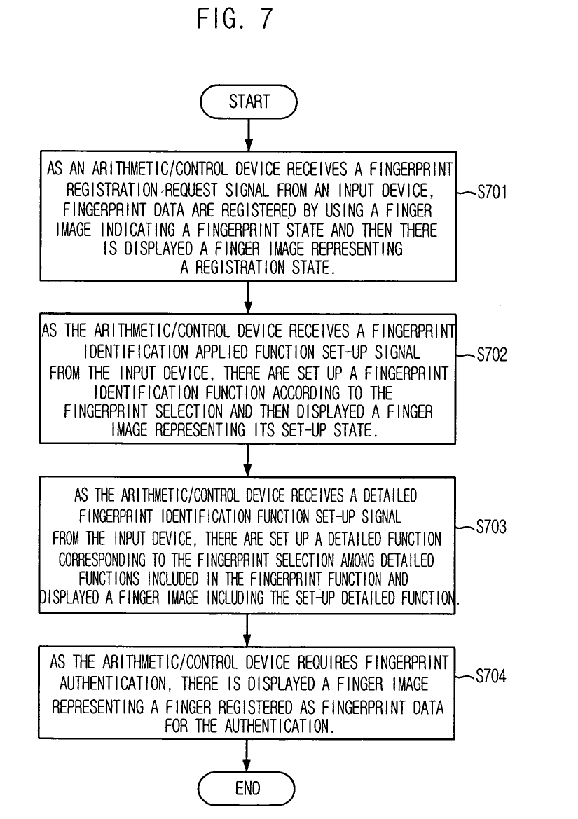

FIG. 7 illustrates a flowchart of showing a method for displaying finger images in the wireless telecommunication terminal in accordance with the present invention.

In step S701, as the arithmetic/control device 103 receives the fingerprint registration request signal from the input device 108, there are displayed on the display device 107 a screen for registering the fingerprint data by using the finger image indicating the fingerprint state, registered the fingerprint data according to the selection of a user, then displayed the finger image representing the registration state.

Subsequently, in step S702, as the arithmetic/control device 103 receives the fingerprint identification function set-up signal from the input device 108, there are displayed on the display device 107 a screen for setting up the fingerprint identification function (e.g., fingerprint registration, speed dial, hot key, security key, authentication, etc.) according to the fingerprint selection to thereby set up the fingerprint identification function according to the selection of the user and displayed the finger image representing the set-up state on the display device 107.

In step S703, as the arithmetic/control device 103 receives the detailed fingerprint identification function set-up signal from the input device 108, there are set up the detailed function corresponding to the fingerprint selection among the detailed functions included in the fingerprint identification function (e.g., fingerprint registration, speed dial, hot key, security dial, authentication, etc.) and displayed the finger image including the set-up detailed function on the display device 107.

In step S704, there is displayed on the display device 107 the finger image representing the finger registered as the fingerprint data for the authentication since the fingerprint authentication is required.

In the embodiment of the present invention, the steps S702, S703 and S704 can be performed in a different order and the steps S702 and S703 can be additional processes. The steps S703 and S704 can be additional processes and the step S704 can be an additional process.

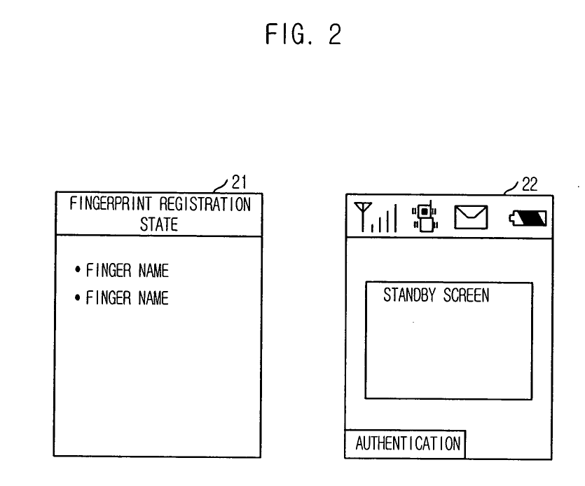

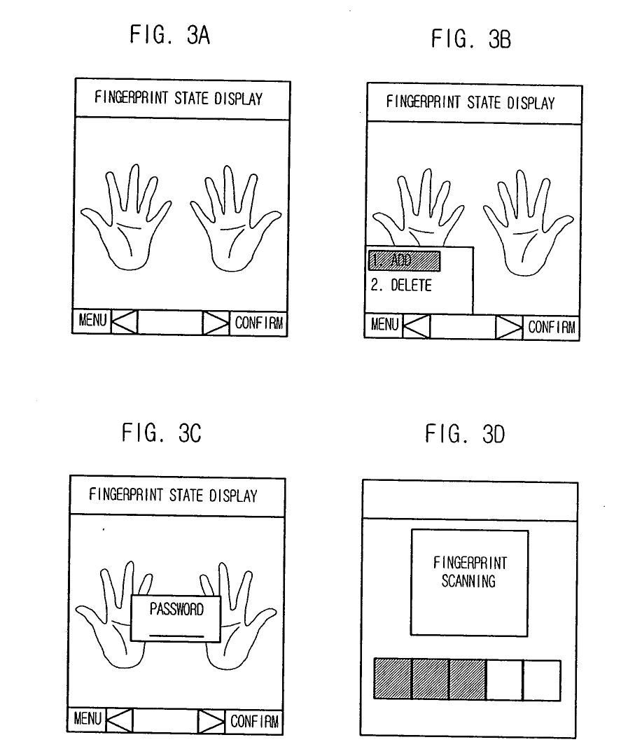

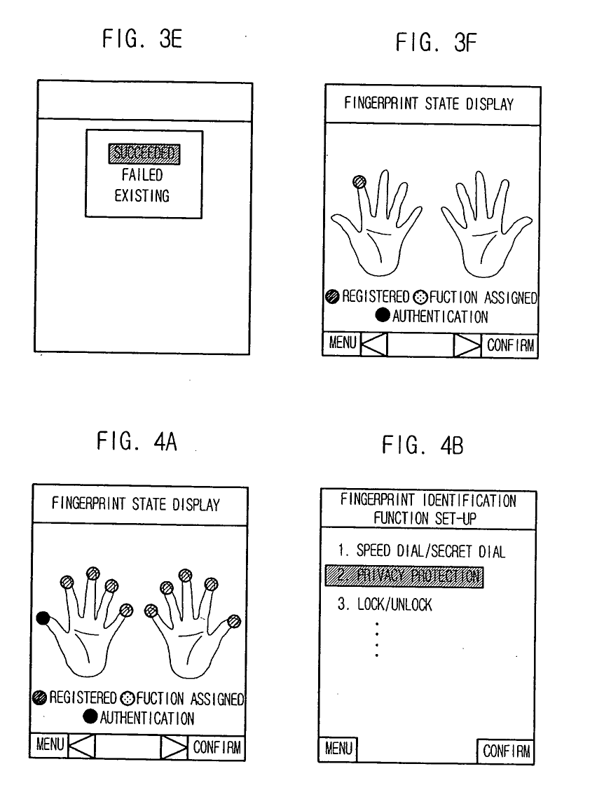

Hereinafter, the steps S701 to S704 in which the arithmetic/control device 103 displays the finger images will be explained in detail with reference to FIGS. 3 to 6.

FIGS. 3A to 3F represent views of explaining a method for displaying the fingerprint registration in the wireless telecommunication terminal in accordance with the present invention.

As the arithmetic/control device 103 receives the fingerprint registration request signal from the user through the input device, there is displayed on the display device 107 a fingerprint state indicating screen of FIG. 3A including a finger image on which a state corresponding to each fingerprint is indicated.

Then, as a fingerprint select signal is inputted through the use of a navigation key in a fingerprint state indicating screen of FIG. 3B and ‘1. add’ is selected, there are displayed on the display device 107 a FIG. 3C for receiving a password so as to register the fingerprint data corresponding to the selected fingerprint and a FIG. 3D for indicating fingerprint scan.

Subsequently, if there is displayed a screen of FIG. 3E reporting that the fingerprint registration is succeeded, there is displayed the fingerprint state indicating screen of FIG. 3F including the finger image on which the registration state corresponding to each fingerprint is indicated.

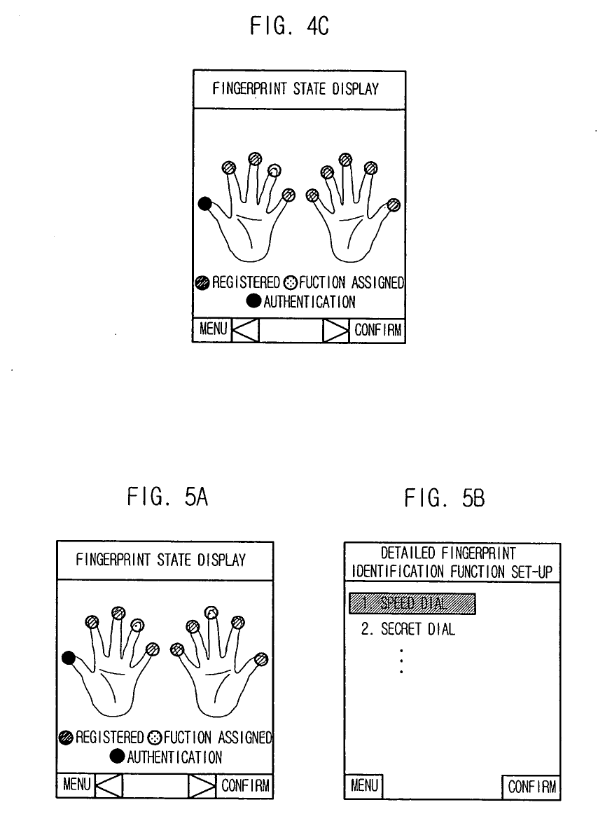

FIGS. 4A to 4C describe views of explaining a method for displaying the establishment of the fingerprint identification function in the wireless telecommunication terminal in accordance with the present invention.

As the arithmetic/control device 103 receives the fingerprint identification function set-up signal from the user through the input device 108, there is displayed on the display device 107 a fingerprint state indicating screen of FIG. 4A including a finger image on which a state of each fingerprint is indicated.

After then, as a fingerprint selection signal is inputted through the use of a navigation key in a fingerprint state indicating screen of FIG. 4A and ‘2. privacy protection’ is selected in a fingerprint identification function set-up screen of FIG. 4B, the display device 107 shows that a fingerprint function is assigned to a selected fingerprint as shown in FIG. 4C.

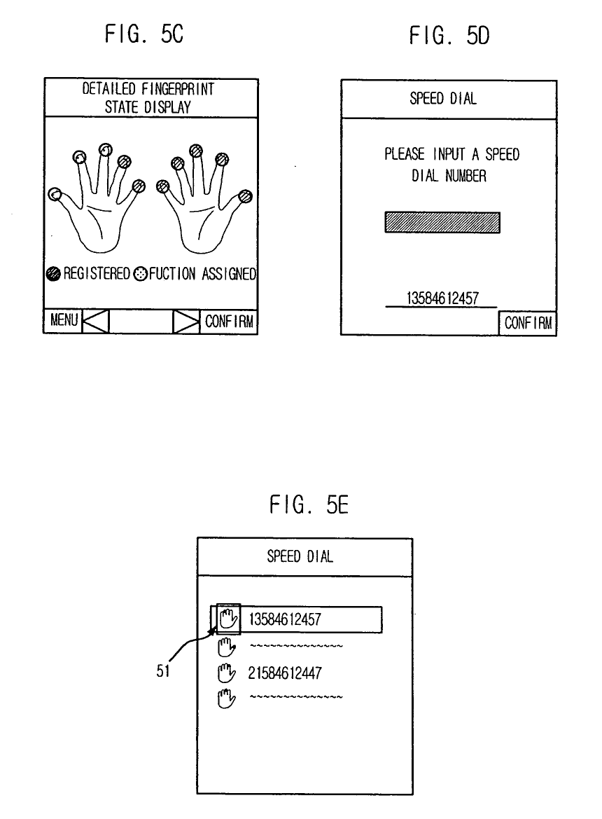

FIGS. 5A to 5E present views of explaining a method for displaying the establishment of the detailed fingerprint identification function in the wireless telecommunication terminal in accordance with the present invention.

As the arithmetic/control device 103 receiving the detailed fingerprint identification function set-up signal from the user through the input device 108, the display device 107 displays a fingerprint state indicating screen of FIG. 5A including a finger image on which a state of each fingerprint is indicated for example the third finger of right hand is assigned as a ‘speed dial’ function, or displays a detailed fingerprint identification function set-up screen of FIG. 5B.

After then, as the third fingerprint of the right hand is selected through a navigation key in a fingerprint state indicating screen of FIG. 5A, or ‘1. speed dial’ is selected in the detailed fingerprint identification function set-up screen of FIG. 5B, the display device 107 shows a FIG. 5C representing that detailed fingerprint functions are assigned to the fingerprints.

If a fingerprint selection signal is inputted through the use of a navigation key in the fingerprint state indicating screen of FIG. 5C and there is inputted a number in a speed dial number input screen of FIG. 5D. There is displayed on the display device 107 a screen of FIG. 5E including a finger image 51 representing fingerprint data for the speed dial.

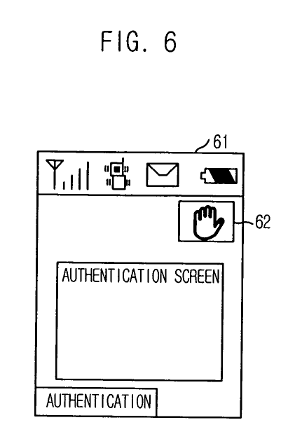

FIG. 6 depicts a view of explaining a method for displaying the fingerprint authentication in the wireless telecommunication terminal in accordance with the present invention.

As the arithmetic/control device 103 needs the fingerprint authentication, there is displayed on the display device 107 a screen 61 including a finger image 62 representing a finger registered as fingerprint data for the authentication at the same time of actuating the fingerprint scan sensor 105.

In accordance with the present invention, as the set-up fingerprint identification function or detailed fingerprint identification function are selected after the set-up process is performed, the finger image representing fingers corresponding to the functions is displayed and then corresponding functions are executed according to the selection of the user.

As described above, the present invention has an effect of providing the user with the visual characteristic, identification and convenience by outputting a finger image on which there is indicated a state of each fingerprint, then, if a certain finger is selected by the user, setting up the fingerprint registration, the fingerprint identification function and the detailed fingerprint identification function for the selected finger, and displaying a finger image corresponding to the selected finger.

The present application contains subject matter related to Korean patent application No. 2004-23751, filed in the Korean Intellectual patent office on Apr. 7, 2004, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

1. A method of utilizing a fingerprint in a wireless telecommunication terminal, comprising:
displaying an image indicative of a hand, the hand image comprising a plurality of fingers; and
displaying information indicative of a fingerprint of a first one of the fingers being registered.

2. The method of claim 1, wherein the fingerprint registration information is displayed along with the hand image.

3. The method of claim 1, further comprising displaying information indicative of which finger is associated with a terminal operating function.

4. The method of claim 1, wherein the plurality of fingers comprises a second finger, and wherein the method further comprises displaying information which indicates that a terminal operating function is assigned to the second finger.

5. The method of claim 4, wherein a fingerprint is registered for the second finger, wherein the method further comprises inputting to the terminal fingerprint information of the second finger, and wherein if the input fingerprint information matches the registered fingerprint, the terminal initiates or continues the terminal operating function.

6. The method of claim 4, wherein the terminal operating function comprises authenticating a user of the terminal when the user attempts to access information stored in the terminal or in a remote electronic device that can be accessed by the terminal.

7. The method of claim 4, wherein the terminal operating function comprises speed dialing which initiates or prepares for connection of the terminal to a remote electronic device without inputting a full number or address of the remote electronic device.

8. The method of claim 1, wherein the plurality of fingers further comprises a third finger, and wherein the method further comprises registering a fingerprint for the third finger.

9. The method of claim 8, wherein registering a fingerprint comprises:
inputting a fingerprint image to the terminal; and
selecting the third finger from the hand image.

10. The method of claim 9, wherein inputting a fingerprint image comprises obtaining a fingerprint image directly from a finger of a user or receiving fingerprint image data from an electronic device connected to the terminal.

11. The method of claim 9, wherein registering a fingerprint comprises storing a fingerprint image for the third finger or replacing a preexisting fingerprint image with a new fingerprint image for the third finger.

12. The method of claim 9, wherein registering a fingerprint further comprises inputting a predetermined user password to the terminal.

13. A method of utilizing a fingerprint in a handheld electronic device, comprising:
displaying information indicative of which finger is associated with a function of the handheld electronic device;
inputting to the device fingerprint information; and
proceeding with operation of the function if the input fingerprint information matches a stored fingerprint information of the finger that is associated with the function.

14. The method of claim 13, wherein the information is displayed along with an image representing a hand.

15. The method of claim 13, wherein the function comprises authenticating a user of the device, and wherein the information is displayed when the user attempts to use the device.

16. The method of claim 13, wherein the function comprises authenticating a user of the device, and wherein the information is displayed when the user attempts to access information stored in the device or in a remote electronic device that can be accessed by the device.

17. The method of claim 13, wherein the information is displayed upon user request or when the function is needed.

18. The method of claim 13, wherein the information is displayed when input fingerprint information fails to match the stored fingerprint of the finger.

19. A method of utilizing a fingerprint in a handheld electronic device, comprising:
displaying an image representing a hand, the image comprising a plurality of fingers; and
displaying information indicative of a function of the device being assigned to one of the fingers.

20. The method of claim 20, further comprising inputting to the device fingerprint information of the finger, and wherein if the input fingerprint information matches a stored fingerprint of the finger to which the function is assigned, the device initiates or continues the device operating function.

21. The method of claim 20, wherein the device operating function comprises authenticating a user of the device, and wherein the information is displayed when the user attempts to access information stored in the device or in a remote electronic device that can be accessed by the device.

22. The method of claim 20, wherein the device operating function comprises speed dialing which initiates or prepares for connection of the device to a remote electronic device without inputting a full number or address of the remote electronic device.
